(19) United States
(12) Patent Application Publication
(10) Pub. No.: US 2014/0280258 A1
(43) Pub. Date: Sep. 18, 2014

(54) Methods and apparatus for exporting digital content using a profile

(71) Applicant: Guy C. Nicholas, Santa Rosa, CA (US)

(72) Inventor: Guy C. Nicholas, Santa Rosa, CA (US)

(21) Appl. No.: 11/369,310

(22) Filed: Mar. 6, 2006

(51) Int. Cl. G06F 17/30; G06F 3/0484

(52) U.S. Cl. CPC G06F 17/30569; G06F 3/04842
USPC 707/756

(57) ABSTRACT

A system examines an object descriptor containing metadata, the metadata associated with a first object. The system identifies at least one characteristic of the first object using the metadata, and applies the at least one characteristic of the first object to a second object. The system exports the second object. The second object is formatted with the at least one characteristic of the first object. Prior to examining the object description, the system receives the first object from a user.

### BACKGROUND

Digital cameras are widely available, at a variety of costs (even low cost ‘disposable’ digital cameras). The photographs created by these digital cameras are digital renditions of the subject matter. These digitally created photographs can be edited, enhanced, modified, stored, or even printed out as the photographic prints commonly used prior to digital photography. Digitally created photographs can be stored on a camera, computer, storage medium, online, etc.

Conventional computerized devices, such as personal computers, laptop computers, and the like allow users to format digital content for exporting. Users can format and export digital photographs in a variety of configurations. For example, digital photographs may be exported via email. When exporting digital photographs via email, the digital photographs are formatted to a size that is compatible with both transmission via email, and viewing when received by the recipient. Digital photographs can also be exported to a television for viewing. Users can compile a selection of digital photographs, format the digital photographs as slideshow photographs, set them to music, and create an entertaining slideshow to be viewed on a television.

### SUMMARY

Conventional technologies for profiling objects for exporting purposes suffer from a variety of deficiencies. In particular, conventional technologies for exporting an object are limited in that a user has to format the object for exporting prior to the step of exporting the object. For example, digital photographs exported to a slide show on a television must be formatted to a specification that's compatible with viewing the digital photographs on the television. This means the user should know what those specifications are prior to attempting to export the digital photographs. While photography professionals may find this task easy, the user, who takes digital photographs as a hobby, may not know (nor want to know) the details regarding various formatting specifications. The user knows the format in which the digital photographs need to be formatted to be compatible with a particular device, but may not know how to correlate that format with the options presented within the digital camera or recording device. Additionally, digital photographs formatted for viewing as a slideshow on a television, may not be viewable on the user's digital camera. Thus, digital photographs formatted for a digital camera may not be viewable on a television, and digital photographs formatted as a slide show for television may not be viewable on the digital camera. This creates a frustrating situation for the user who simply wants to be able to view digital photographs in a variety of formats, without having to be an expert in digital composition.

Embodiments disclosed herein significantly overcome such deficiencies and provide a system that includes a computer system executing an object profiling process that identifies the formatting specifications (i.e., creates a ‘profile’) of a first object, and formats a second object per those specifications. The user need only identify the first object, and the object profiling process formats the second object per a profile associated with the first object. Thus, the user does not need to know the details associated with the first object. In one embodiment, the user selects the first object from a graphical user interface. In another embodiment, the user selects the method of exporting, for example, formatting digital photographs for viewing on a television, as a slideshow, and the object profiling process formats the digital photographs in the appropriate format (i.e., the format required for the selected method of exporting).

Embodiments disclosed herein provide a computer system executing an object profiling process that examines an object descriptor containing metadata. Prior to examining the object description, the object profiling process receives the first object from a user. The metadata is associated with a first object. The object profiling process identifies at least one characteristic of the first object using the metadata, and applies the at least one characteristic of the first object to a second object. The object profiling process exports the second object, with the second object formatted with the at least one characteristic of the first object.

During an example operation of one embodiment, suppose a user has several digital photographs, stored on a digital camera, that the user would like to format for viewing as a slide show on a television. Via a graphical user interface, the user chooses a sample photograph previously formatted for viewing as a slide show on a television. The user does not need to know the technical details of the sample photograph, only that the user wishes to have the digital photographs stored on the digital camera, formatted in the manner as the sample photograph selected by the user. In one embodiment, the sample photograph is solely used as an example to enable the user to select a method of exporting. In another embodiment, the sample photograph is a photograph (belonging to the user) that has previously been formatted for viewing as a slide show on a television. The object profiling process examines the characteristics (i.e., the metadata) associated with the selected sample photograph, and identifies those characteristics specifically associated with the format of the sample photograph. The object profiling process applies those identified characteristics to the digital photographs stored on the user's digital camera, and exports those digital photographs (formatted for viewing as a slideshow on a television) to the television for viewing.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein as embodiments disclosed herein.

It is to be understood that the system disclosed herein may be embodied strictly as a software program, as software and hardware, or as hardware alone. The embodiments disclosed herein may be employed in data communications devices and other computerized devices and software systems for such devices such as those manufactured by Adobe Systems, Inc., of San Jose, Calif.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a computer system according to one embodiment disclosed herein.

FIG. 2 illustrates a flowchart of a procedure performed by the system of FIG. 1 when the object profiling process examines an object descriptor containing metadata, the metadata associated with a first object, according to one embodiment disclosed herein.

FIG. 3 illustrates a flowchart of a procedure performed by the system of FIG. 1 when the object profiling process, prior to examining the object description, receives the first object from a user, according to one embodiment disclosed herein.

FIG. 4 illustrates a flowchart of a procedure performed by the system of FIG. 1 when the object profiling process identifies at least one characteristic of the first object using the metadata, according to one embodiment disclosed herein.

FIG. 5 illustrates a flowchart of a procedure performed by the system of FIG. 1 when the object profiling process applies the at least one characteristic of the first object to a second object, according to one embodiment disclosed herein.

FIG. 6 illustrates a flowchart of a procedure performed by the system of FIG. 1 when the object profiling process exports the second object, the second object formatted with the at least one characteristic of the first object, according to one embodiment disclosed herein.

### DETAILED DESCRIPTION

Embodiments disclosed herein provide a computer system executing an object profiling process that identifies the formatting specifications (i.e., creates a ‘profile’) of a sample first object, and formats a second object per those specifications. The user need only identify the sample first object, and the object profiling process formats the second object per a profile associated with the sample first object. Thus, the user does not need to know the details associated with the first object. In one embodiment, the user selects the sample first object from a graphical user interface. In another embodiment, the user selects the method of exporting a second object, for example, formatting digital photographs for viewing on a television, as a slideshow, and the object profiling process formats the digital photographs in the appropriate format (i.e., the format required for the selected method of exporting).

Embodiments disclosed herein provide a computer system executing an object profiling process that examines an object descriptor containing metadata. Prior to examining the object description, the object profiling process receives the first object from a user. The metadata is associated with a first object. The object profiling process identifies at least one characteristic of the first object using the metadata, and applies the at least one characteristic of the first object to a second object. The object profiling process exports the second object, with the second object formatted with the at least one characteristic of the first object.

FIG. 1 is a block diagram illustrating example architecture of a computer system 110 that executes, runs, interprets, operates or otherwise performs an object profiling application 140-1 and object profiling process 140-2 suitable for use in explaining example configurations disclosed herein. The computer system 110 may be any type of computerized device such as a personal computer, workstation, portable computing device, console, laptop, network terminal or the like. An input device 116 (e.g., one or more user/developer controlled devices such as a keyboard, mouse, etc.) couples to processor 113 through I/O interface 114, and enables a user 108 to provide input commands, and generally control the graphical user interface 160 that the object profiling application 140-1 and process 140-2 provides on the display 130. The graphical user interface 160 displays a first object 150, a second object 155, and a plurality of objects 175-N (including the first object 150). The first object has characteristics 165-N associated with the first object 150. Those characteristics 165-N are used to create a profile 170 associated with the first object 150. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with an object profiling application 140-1 that includes a graphical user interface 160 displaying a first object 150, a second object 155, and a plurality of objects 175-N (including the first object 150) as explained herein. The object profiling application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of the object profiling application 140-1. Execution of the object profiling application 140-1 in this manner produces processing functionality in an object profiling process 140-2. In other words, the object profiling process 140-2 represents one or more portions or runtime instances of the object profiling application 140-1 (or the entire object profiling application 140-1) performing or executing within or upon the processor 113 in the computerized device 110 at runtime.

It is noted that example configurations disclosed herein include the object profiling application 140-1 itself (i.e., in the form of un-executed or non-performing logic instructions and/or data). The object profiling application 140-1 may be stored on a computer readable medium (such as a floppy disk), hard disk, electronic, magnetic, optical, or other computer readable medium. The object profiling application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of the object profiling application 140-1 in the processor 113 as the object profiling process 140-2. Those skilled in the art will understand that the computer system 110 may include other processes and/or software and hardware components, such as an operating system not shown in this example.

A display 130 need not be coupled directly to computer system 110. For example, the object profiling application 140-1 can be executed on a remotely accessible computerized device via the network interface 115. In this instance, the graphical user interface 160 may be displayed locally to a user 108 of the remote computer and execution of the processing herein may be client-server or web-server based. Further details of configurations explained herein will now be provided with respect to a flow chart of processing steps that show the high level operations disclosed herein to perform the object profiling process 140-2.

FIG. 2 is an embodiment of the steps performed by the object profiling process 140-2 when it examines an object descriptor containing metadata to identify at least one characteristic 165-1 of the first object 150.

In step 200, the object profiling process 140-2 examines an object descriptor containing metadata, the metadata associated with a first object 150. In an example configuration, the first object 150 is a digital photograph. The file that represents the digital photograph (i.e., the first object 150) contains the digital representation of the digital photograph (i.e., the first object 150) as well as data pertaining to the digital photograph (i.e., the first object 150). The data pertaining to the digital photograph (i.e., the first object 150) is metadata associated with a first object 150. The metadata can include, for example, size, compression, Exchangeable Image File (EXIF) data, etc. The object profiling process 140-2 examines this metadata associated with the digital photograph (i.e., the first object 150). In an example embodiment, the first object 150 can include other types of digital content such as audio, video, graphical images, etc.

In step 201, the object profiling process 140-2 identifies at least one characteristic 165-1 of the first object 150 using the metadata. In an example configuration, the first object 150 is a digital photograph, and the characteristic 165-1 associated with the digital photograph (i.e., the first object 150) is EXIF data. The object profiling process identifies at least one EXIF datum (i.e., a characteristic 165-1) of the digital photograph (i.e., the first object 150) using the metadata. Examples of EXIF data (i.e., the characteristic 165-1 of the first object 150) can include: name of the digital photograph (i.e., the first object 150), name of the camera with which the digital photograph (i.e., the first object 150) was taken, timestamp associated with the creation of the digital photograph (i.e., the first object 150), shooting mode, photo effect, shutter speed, aperture value, light metering, exposure compensation, ISO speed, lens, focal length, digital zoom, image size, image quality, flash, flash type, color space, software used to view/modify the digital photograph (i.e., the first object 150), etc.

In step 202, the object profiling process 140-2 applies the at least one characteristic 165-1 of the first object 150 to a second object 155. In an example configuration, the first object 150 is a first digital photograph. The object profiling process 140-2 examines the metadata associated with the first digital photograph (i.e., the first object 150), and identifies at least one characteristic 165-1 of the first object 150 using the metadata. For example, the object profiling process 140-2 identifies, as the characteristic 165-1, the software used to view/modify the first digital photograph (i.e., the first object 150), and applies this characteristic 165-1 to a second object 155, for example, a second digital photograph. Thus, when a user 108 accesses the second digital photograph (i.e., the second object 155), the second digital photograph will be opened using the editing software (i.e., the characteristic 165-1) associated with the first digital photograph (i.e., the first object 150).

In step 203, the object profiling process 140-2 exports the second object 155, the second object 155 formatted with the at least one characteristic 165-1 of the first object 150. In an example configuration, the first object 150 is a first digital photograph. The object profiling process 140-2 examines the metadata associated with the first digital photograph (i.e., the first object 150). The object profiling process 140-2 identifies at least one characteristic 165-1, for example, the image size, of the first digital photograph (i.e., the first object 150). The object profiling process 140-2 applies the image size (i.e., the characteristic 165-1) of the first digital photograph (i.e., the first object 150) to a second digital photograph (i.e., a second object 155), and exports the second digital photograph via email. The second digital photograph (i.e., a second object 155) is formatted with the image size (i.e., the characteristic 165-1) of the first digital photograph (i.e., the first object 150). The object profiling process 140-2 then exports the second digital photograph (i.e., a second object 155) is formatted with the image size (i.e., the characteristic 165-1) of the first digital photograph (i.e., the first object 150).

In step 204, the object profiling process 140-2, prior to examining the object description, receives the first object 150 from a user 108. In an example configuration, the first object 150 is a first digital photograph provided by a user 108. The object profiling process 140-2 examines the metadata associated with the first digital photograph (i.e., the first object 150), and identifies at least one characteristic 165-1, for example, the image size, of the first digital photograph (i.e., the first object 150). The object profiling process 140-2 applies the image size (i.e., the characteristic 165-1) of the first digital photograph (i.e., the first object 150) to a second digital photograph (i.e., a second object 155), and exports the second digital photograph via email. The second digital photograph (i.e., a second object 155) is formatted with the image size (i.e., the characteristic 165-1) of the first digital photograph (i.e., the first object 150). Thus, the user 108 need only identify the first digital photograph (i.e., the first object 150), and the object profiling process 140-2 formats the second digital photograph (i.e., a second object 155) in the same manner as the first digital photograph (i.e., the first object 150). The user 108 does not need to know the image size (i.e., the characteristic 165-1) of the first digital photograph (i.e., the first object 150), only that the first digital photograph was formatted properly for emailing, and that the user wishes to have the second digital photograph (i.e., a second object 155) formatted in the same manner for emailing as the first digital photograph (i.e., the first object 150).

FIG. 3 is an embodiment of the steps performed by the object profiling process 140-2 when it receives the first object 150 from a user 108 prior to examining the object description.

In step 205, the object profiling process 140-2, prior to examining the object description, receives the first object 150 from a user 108. In an example configuration, the first object 150 is a first digital photograph provided by a user 108. The object profiling process 140-2 examines the metadata associated with the first digital photograph (i.e., the first object 150), and identifies at least one characteristic 165-1, for example, the image size, of the first digital photograph (i.e., the first object 150). The object profiling process 140-2 applies the image size (i.e., the characteristic 165-1) of the first digital photograph (i.e., the first object 150) to a second digital photograph (i.e., a second object 155), and exports the second digital photograph via email. The second digital photograph (i.e., a second object 155) is formatted with the image size (i.e., the characteristic 165-1) of the first digital photograph (i.e., the first object 150). Thus, the user 108 need only identify the first digital photograph (i.e., the first object 150), and the object profiling process 140-2 formats the second digital photograph (i.e., a second object 155) in the same manner as the first digital photograph (i.e., the first object 150). The user 108 does not need to know the image size (i.e., the characteristic 165-1) of the first digital photograph (i.e., the first object 150), only that the first digital photograph was formatted properly for emailing, and that the user wishes to have the second digital photograph (i.e., a second object 155) formatted in the same manner for emailing as the first digital photograph (i.e., the first object 150).

In step 206, the object profiling process 140-2 receives the first object 150 via a graphical user interface 160 wherein the first object 150 is selected by the user 108, as a profile 170, by which the second object 155 will be formatted. In an example embodiment, prior to examining the object descriptor, the object profiling process 140-2 receives the first object 150, from the user 108, via a graphical user interface 160. In one embodiment, the graphical user interface 160 resides on the camera of the user 108. In another example embodiment, the graphical user interface 160 resides on a computer system on which the user 108 has downloaded the first object 150, for example, a digital photograph.

In step 207, the object profiling process 140-2 receives from the user 108 a selection of a method of exporting the second object 155. In an example configuration, the second object 155 is a second digital photograph. The user 108 selects a method of exporting the second digital photograph (i.e., the second object 155). For example, the user 108, via the graphical user interface 160, chooses to email the second digital photograph (i.e., the second object 155). The object profiling process 140-2 receives the selection of the method of exporting (i.e., emailing the second digital photograph), from the user 108. The user 108 does not need to know the characteristics 165-N of the first digital photograph (i.e., the first object 150), only that the first digital photograph was formatted properly, and that the user wishes to have the second digital photograph (i.e., a second object 155) formatted in the same manner as the first digital photograph (i.e., the first object 150).

Based on the selection of a method of exporting the second object 155, in step 208, the object profiling process 140-2, determines a first object 150 to be used as a profile 170 for exporting the second object 155. In an example configuration, the second object 155 is a second digital photograph. The user 108 selects a method of exporting the second digital photograph (i.e., the second object 155). For example, the user 108, via the graphical user interface 160, chooses to email (i.e., the method of exporting the second object 155) the second digital photograph (i.e., the second object 155). Based on the user's 108 selection of emailing as the method of exporting the second digital photograph (i.e., the second object 155), the object profiling process 140-2, determines a first digital photograph (i.e., a first object 150) to be used as a profile 170 for exporting (i.e., emailing) the second digital photograph (i.e., the second object 155). In an example embodiment, object profiling process 140-2 determines the first digital photograph (i.e., a first object 150) is to be used as a profile 170, based on the image size (i.e., the characteristic 165-1) of the first digital photograph (i.e., a first object 150). In this example, the object profiling process 140-2 receives the method of exporting, and determines the first object 150 with which to format the second object 155, based on the method of exporting chosen for the second object 155.

Alternatively, in step 209, the object profiling process 140-2 provides a plurality of sample objects 175, including the first object 150, to the user 108. In an example embodiment, the plurality of sample objects 175 is a plurality of digital photographs, including a first digital photograph (i.e., the first object 150). The object profiling process 140-2 provides a plurality of digital photographs (i.e., plurality of sample objects 175), including the first digital photograph (i.e., the first object 150) to the user 108, via the graphical user interface 160. The plurality of digital photographs (i.e., plurality of sample objects 175), including the first digital photograph (i.e., the first object 150) represents a plurality of profiles 170 by which a second digital photograph (i.e., the second object 155) can be formatted.

In step 210, the object profiling process 140-2 receives a selection of the first object 150 from the plurality of sample objects 175, from the user 108, the selection of the first object 150 indicating a method by which the user 108 intends to export the second object 155. In an example embodiment, the plurality of sample objects 175 is a plurality of digital photographs, including a first digital photograph (i.e., the first object 150). The object profiling process 140-2 provides a plurality of digital photographs (i.e., plurality of sample objects 175), including the first digital photograph (i.e., the first object 150) to the user 108, via the graphical user interface 160. The user 108 selects the first digital photograph (i.e., the first object 150) from the plurality of digital photographs (i.e., plurality of sample objects 175). The selection of the first digital photograph (i.e., the first object 150) indicates a method by which the user 108 wishes the second photograph (i.e., the second object 155) to be exported. For example, the object profiling process 140-2 determines the first digital photograph (i.e., a first object 150) is formatted with an image size (i.e., the characteristic 165-1) suitable for emailing. Thus, the object profiling process 140-2 receives the selection of the first digital photograph (i.e., the first object 150), formatted for emailing. This indicates the user 108 intends to export the second digital photograph (i.e., the second object 155) via email. Therefore, the process profiling process 140-2 formats the second digital photograph (i.e., the second object 155) with an image size (i.e., the characteristic 165-1) suitable for emailing. The user 108 does not need to know the characteristics 165-N of the first digital photograph (i.e., the first object 150), only that the first digital photograph was formatted properly, and that the user wishes to have the second digital photograph (i.e., a second object 155) formatted in the same manner as the first digital photograph (i.e., the first object 150).

FIG. 4 is an embodiment of the steps performed by the object profiling process 140-2 when it identifies at least one characteristic 165-1 of the first object 150 using the metadata associated with the first object 150.

In step 211, the object profiling process 140-2 identifies at least one characteristic 165-1 of the first object 150 using the metadata. In an example configuration, the first object 150 is a digital photograph, and the characteristic 165-1 associated with the digital photograph (i.e., the first object 150) is EXIF data. The object profiling process identifies at least one EXIF datum (i.e., a characteristic 165-1) of the digital photograph (i.e., the first object 150) using the metadata. Examples of EXIF data (i.e., the characteristic 165-1 of the first object 150) can include: name of the digital photograph (i.e., the first object 150), name of the camera with which the digital photograph (i.e., the first object 150) was taken, timestamp associated with the creation of the digital photograph (i.e., the first object 150), shooting mode, photo effect, shutter speed, aperture value, light metering, exposure compensation, ISO speed, lens, focal length, digital zoom, image size, image quality, flash, flash type, color space, software used to view/modify the digital photograph (i.e., the first object 150), etc.

In step 212, the object profiling process 140-2 provides the user 108 with the at least one characteristic 165-1, the at least one characteristic 165-1 associated with the selection of the first object 150 from the plurality of objects 175. In an example configuration, the first object 150 is a first digital photograph. The object profiling process 140-2 receives the selection of the first digital photograph (i.e., the first object 150) from the user 108 via the graphical user interface 160. The object profiling process 140-2 identifies at least one characteristic 165-1 of the first digital photograph (i.e., the first object 150) using metadata associated with the first digital photograph (i.e., the first object 150), and presents the at least one characteristic 165-1 to the user 108 via the graphical user interface 160. For example, the object profiling process 140-2 provides the user 108, via the graphical user interface 160, a plurality of characteristics 165-N, such as shooting mode, photo effect, shutter speed, aperture value, light metering, exposure compensation, ISO speed, lens, focal length, digital zoom, image size, image quality, flash, flash type, color space, software used to view/modify the digital photograph (i.e., the first object 150), etc.

In step 213, the object profiling process 140-2 receives a selection of the at least one characteristic 165-1 from the user 108. In an example configuration, the first object 150 is a first digital photograph. The object profiling process 140-2 receives the selection of the first digital photograph (i.e., the first object 150) from the user 108 via the graphical user interface 160, and identifies at least one characteristic 165-1 of the first digital photograph (i.e., the first object 150) using metadata associated with the first digital photograph (i.e., the first object 150). The object profiling process 140-2 presents the at least one characteristic 165-1 to the user 108 via the graphical user interface 160, and receives a selection of the at least one characteristic 165-1 from the user 108. For example, the object profiling process 140-2 provides the user 108, via the graphical user interface 160, a plurality of characteristics 165-N, such as shooting mode, photo effect, shutter speed, aperture value, light metering, exposure compensation, ISO speed, lens, focal length, digital zoom, image size, image resolution quality, flash, flash type, color space, software used to view/modify the first digital photograph (i.e., the first object 150), etc. The object profiling process 140-2 receives a selection of the software used to view/modify the first digital photograph (i.e., the first object 150). In this scenario, the user 108 may want to view/modify a second digital photograph (i.e., a second object 155) using the same software application with which the first digital photograph (i.e., the first object 150) was viewed and/or modified. The user 108 may not know which software application used, but by selecting the first digital photograph (i.e., the first object 150), and being able to view the characteristics 165-N associated with the first digital photograph (i.e., the first object 150), the user 108 can make the proper selection. Thus, the user 108 does not need to know which software application was used. The user 108 only needs to select a sample object 150 that can be used as a profile 170.

In step 214, the object profiling process 140-2 identifies at least one of: a file size of the first object 150, a file type of the first object 150, an amount of compression associated with the first object 150, and a width and height of the first object 150. In an example configuration, the first object 150 is a first digital photograph. The object profiling process 140-2 identifies at least one characteristic 165-1 of the first digital photograph (i.e., the first object 150) using metadata associated with the first digital photograph (i.e., the first object 150). For example, the characteristic 165-1 can include a file size of the first digital photograph (i.e., the first object 150), a file type of the first digital photograph (i.e., the first object 150), an amount of compression associated with the first digital photograph (i.e., the first object 150), and a width and height of the first digital photograph (i.e., the first object 150), as well as other characteristics 165-N.

FIG. 5 is an embodiment of the steps performed by the object profiling process 140-2 when it applies the at least one characteristic 165-1 of the first object 150 to a second object 155.

In step 215, the object profiling process 140-2 applies the at least one characteristic 165-1 of the first object 150 to a second object 155. In an example configuration, the first object 150 is a first digital photograph. The object profiling process 140-2 examines the metadata associated with the first digital photograph (i.e., the first object 150), and identifies at least one characteristic 165-1 of the first object 150 using the metadata. For example, the object profiling process identifies, as the characteristic 165-1, the software used to view/modify the first digital photograph (i.e., the first object 150), and applies this characteristic 165-1 to a second object 155, for example, a second digital photograph. Thus, when a user 108 accesses the second digital photograph (i.e., the second object 155), the second digital photograph will be opened using the editing software (i.e., the characteristic 165-1) associated with the first digital photograph (i.e., the first object 150). In an example embodiment the first object 150 is a first document. The user 108 selects an option, such as “Save Like”, and at least one characteristic 165-1 associated with the first document (i.e., the first object 150) is applied to a second document (i.e., a second object 155).

In step 216, the object profiling process 140-2 creates a profile 170 of the first object 150, based on the at least on characteristic 165-1. In an example configuration, the first object 150 is a first digital photograph. The object profiling process 140-2 examines the metadata associated with the first digital photograph (i.e., the first object 150), and identifies at least one characteristic 165-1 of the first object 150 using the metadata. For example, the at least one characteristic 165-1 identified by the object profiling process 140-2 is the image size of the first digital photograph (i.e., the first object 150). The object profiling process 140-2 creates a profile 170 of the first digital photograph (i.e., the first object 150) based on the image size (i.e., the characteristic 165-1) of the first digital photograph (i.e., the first object 150). The profile 170 can contain one or more characteristics 165-N, and is used to format the second object 155, such as a second digital photograph.

In step 217, the object profiling process 140-2 eliminates extraneous data contained within the at least one characteristic 165-1 to ensure the second object 155 is accessible, the extraneous data potentially causing the second object 155 to be inaccessible. In an example configuration, the first object 150 is a first digital photograph. The object profiling process 140-2 examines the metadata associated with the first digital photograph (i.e., the first object 150), and identifies at least one characteristic 165-1 of the first object 150 using the metadata. For example, the at least one characteristic 165-1 identified by the object profiling process 140-2 is the software used to edit the first digital photograph (i.e., the first object 150). The object profiling process 140-2 creates a profile 170 of the first digital photograph (i.e., the first object 150) based on the software used to edit the first digital photograph (i.e., the first object 150). In this scenario, the software used to edit the first digital photograph (i.e., the first object 150) adds extraneous data that renders the first digital photograph (i.e., the first object 150) inaccessible when the first digital photograph (i.e., the first object 150) resides on the user's 108 camera. The object profiling process 140-2 eliminates this extraneous data contained within the metadata associated with the editing software (i.e., the characteristic 165-1) to ensure the second digital photograph (i.e., the second object 155) is accessible.

Alternatively, in step 218, the object profiling process 140-2 identifies a location where the first object 150 resides. In an example configuration, the first object 150 is a first digital photograph. The object profiling process 140-2 identifies a location where the first digital photograph (i.e., the first object 150) resides. For example, the first digital photograph (i.e., the first object 150) is stored on the user's 108 computer, and the object profiling process 140-2 identifies the folder in which the first digital photograph (i.e., the first object 150) resides.

In step 219, the object profiling process 140-2 identifies that a plurality of objects 175 residing at the location are formatted according to the profile 170. In an example configuration, the first object 150 is a first digital photograph. The object profiling process 140-2 examines the metadata associated with the first digital photograph (i.e., the first object 150), and identifies at least one characteristic 165-1 of the first object 150 using the metadata. The object profiling process 140-2 creates a profile 170 of the first digital photograph (i.e., the first object 150) based on the characteristic 165-1 associated with first digital photograph (i.e., the first object 150). The object profiling process 140-2 identifies a location where the first digital photograph (i.e., the first object 150) resides. The object profiling process identifies that a plurality of photographs (i.e., a plurality of objects 175), also located at that location, are formatted according to the profile 170. For example, the first digital photograph (i.e., the first object 150) is stored on the user's 108 computer, and the object profiling process 140-2 identifies the folder in which the first digital photograph (i.e., the first object 150) resides. The object profiling process 140-2 also identifies a profile 170 associated with the first digital photograph (i.e., the first object 150). The object profiling process 140-2 identifies that a plurality of photographs (i.e., a plurality of objects 175) reside at the same location as the first digital photograph (i.e., the first object 150), and are also associated with the same profile 170 as the first digital photograph (i.e., the first object 150).

In step 220, the object profiling process 140-2 formats the second object 155 according to the profile 170. In an example configuration, the first object 150 is a first digital photograph. The object profiling process 140-2 examines the metadata associated with the first digital photograph (i.e., the first object 150), and identifies at least one characteristic 165-1 of the first object 150 using the metadata. For example, the object profiling process identifies, as the characteristic 165-1, the image size of the first digital photograph (i.e., the first object 150), and formats a second object 155, for example, a second digital photograph, with the same image size (i.e., characteristic 165-1) as the first digital photograph (i.e., the first object 150).

In step 221, the object profiling process 140-2 stores the second object 155 at the same location of the first object 150. In an example configuration, the first object 150 is a first digital photograph. The object profiling process 140-2 examines the metadata associated with the first digital photograph (i.e., the first object 150), and identifies at least one characteristic 165-1 of the first object 150 using the metadata. The object profiling process 140-2 creates a profile 170 of the first digital photograph (i.e., the first object 150) based on the characteristic 165-1 associated with first digital photograph (i.e., the first object 150). The object profiling process 140-2 identifies a location where the first digital photograph (i.e., the first object 150) resides. For example, the first digital photograph (i.e., the first object 150) is stored on the user's 108 computer, and the object profiling process 140-2 identifies the folder in which the first digital photograph (i.e., the first object 150) resides. The object profiling process 140-2 also identifies a profile 170 associated with the first digital photograph (i.e., the first object 150). The object profiling process 140-2 formats a second digital photograph (i.e., a second object 155) using the profile 170 and stores the second digital photograph (i.e., a second object 155) at the location where the first digital photograph (i.e., the first object 150) resides. Thus, a user 108 identifies a first digital photograph (i.e., the first object 150), and the object profiling process 140-2 formats a second digital photograph (i.e., a second object 155) according to the profile 170,and stores the second digital photograph (i.e., a second object 155) at the location where the first digital photograph (i.e., the first object 150) resides.

FIG. 6 is an embodiment of the steps performed by the object profiling process 140-2 when exports the second object 155 formatted with the at least one characteristic 165-1 of the first object 150.

In step 222, the object profiling process 140-2 exports the second object 155, the second object 155 formatted with the at least one characteristic 165-1 of the first object 150. In an example configuration, the first object 150 is a first digital photograph. The object profiling process 140-2 examines the metadata associated with the first digital photograph (i.e., the first object 150). The object profiling process 140-2 identifies at least one characteristic 165-1, for example, the image size, of the first digital photograph (i.e., the first object 150). The object profiling process 140-2 applies the image size (i.e., the characteristic 165-1) of the first digital photograph (i.e., the first object 150) to a second digital photograph (i.e., a second object 155), and exports the second digital photograph via email. The second digital photograph (i.e., a second object 155) is formatted with the image size (i.e., the characteristic 165-1) of the first digital photograph (i.e., the first object 150). The object profiling process 140-2 then exports the second digital photograph (i.e., a second object 155) is formatted with the image size (i.e., the characteristic 165-1) of the first digital photograph (i.e., the first object 150).

In step 223, the object profiling process 140-2 exports the second object 155 with information associated with the second object 155, the information including at least one of: a name of a user 108 responsible for creating the second object 155, a name of a user 108 responsible for editing the second object 155, and at least one second object metadata associated with the second object 155. In an example configuration, the first object 150 is a first digital photograph. The object profiling process 140-2 identifies at least one characteristic 165-1, for example, the image size, of the first digital photograph (i.e., the first object 150). The object profiling process 140-2 applies the image size (i.e., the characteristic 165-1) of the first digital photograph (i.e., the first object 150) to a second digital photograph (i.e., a second object 155), and exports the second digital photograph via email. The second digital photograph (i.e., a second object 155) is formatted with the image size (i.e., the characteristic 165-1) of the first digital photograph (i.e., the first object 150). In one embodiment, the second digital photograph (i.e., a second object 155) is exported with information such as a name of a user 108 responsible for creating the second digital photograph (i.e., a second object 155), a name of a user 108 responsible for editing the second digital photograph (i.e., a second object 155), and at least one second object metadata associated with the second digital photograph (i.e., a second object 155).

In step 224, the object profiling process 140-2 receives a selection from a user 108 to store the second object 155. In an example configuration, the first object 150 is a first digital photograph. The object profiling process 140-2 examines the metadata associated with the first digital photograph (i.e., the first object 150). The object profiling process 140-2 identifies at least one characteristic 165-1, for example, the image size, of the first digital photograph (i.e., the first object 150). The object profiling process 140-2 applies the image size (i.e., the characteristic 165-1) of the first digital photograph (i.e., the first object 150) to a second digital photograph (i.e., a second object 155). The second digital photograph (i.e., a second object 155) is formatted with the image size (i.e., the characteristic 165-1) of the first digital photograph (i.e., the first object 150). In one embodiment, the object profiling process 140-2 exports the second digital photograph (i.e., a second object 155). In another embodiment, the object profiling process 140-2 receives a selection from a user 108 to store the second digital photograph (i.e., a second object 155) is formatted with the image size (i.e., the characteristic 165-1) of the first digital photograph (i.e., the first object 150). For example, the user 108 wishes to store the second digital photograph (i.e., a second object 155) formatted with the image size (i.e., the characteristic 165-1) of the first digital photograph (i.e., the first object 150) on the user's 108 computer. The user 108 does not need to know the characteristics 165-N of the first digital photograph (i.e., the first object 150), only that the first digital photograph was formatted properly, and that the user wishes to have the second digital photograph (i.e., a second object 155) formatted in the same manner as the first digital photograph (i.e., the first object 150). In an example embodiment, the first object 150 is written content, such as a text document.

In step 225, the object profiling process 140-2 stores the second object 155. In an example embodiment, the second digital photograph (i.e., a second object 155) is formatted with the image size (i.e., the characteristic 165-1) of the first digital photograph (i.e., the first object 150). The object profiling process 140-2 receives a selection from a user 108 to store the second digital photograph (i.e., a second object 155) formatted with the image size (i.e., the characteristic 165-1) of the first digital photograph (i.e., the first object 150), and the object profiling process 140-2 stores the second digital photograph (i.e., a second object 155) on the user's 108 computer.

While computer systems and methods have been particularly shown and described above with references to configurations thereof, it will be understood by those skilled in the art that various changes in form and details may be made therein without departing from the scope disclosed herein. Accordingly, embodiments disclosed herein are not intended to be limited by the example configurations provided above.

1. A computerized device comprising:
a memory;
a processor;
a communications interface; and
an interconnection mechanism coupling the memory, the processor and the communications interface;
wherein the memory is encoded with a object profiling application that when executed on the processor provides object profiling on the computerized device by performing the operations of:
examining an object descriptor containing metadata, the metadata associated with a first object;
identifying at least one formatting characteristic of the first object using the metadata;
applying the at least one formatting characteristic of the first object to a second object to alter the format of the second object without adding content to the second object, wherein applying the at least one formatting characteristic of the first object to the second object comprises accessing a profile of the first object, the profile defining one or more formatting characteristics of the first object, and formatting the second object according to the profile; and
exporting a formatted version of the second object, wherein the formatted version of the second object is formatted with the at least one formatting characteristic of the first object and is exported as an object separately accessible from the first object.

2. The computerized device of claim 1 wherein the computerized device performs the further operation of:
prior to examining the object description, receiving input identifying the first object via a graphical user interface, the first object being selected as a profile by which the second object is to be formatted.

3. (canceled)

4. The computerized device of claim 2 wherein receiving input identifying the first object via the graphical user interface comprises:
receiving a selection of a method of exporting the second object; and
based on the selection of a method of exporting the second object, determining a first object to be used as a profile for exporting the second object.

5. The computerized device of claim 2, wherein receiving input identifying the first object via the graphical user interface comprises:
providing a plurality of sample objects including the first object; and
receiving a selection of the first object from the plurality of sample objects.

6. (canceled)

7. The computerized device of claim 1 wherein identifying at least one formatting characteristic of the first object and applying the least one formatting characteristic formatting to the second object comprises identifying and applying a file type of the first object.

8. (canceled)

9. The computerized device of claim 1, further comprising creating the profile of the first object based on the one or more formatting characteristics, wherein creating the profile comprises eliminating extraneous data contained within the one or more formatting characteristics to ensure the second object is accessible, the extraneous data potentially causing the second object to be inaccessible.

10. The computerized device of claim 9 wherein creating the profile comprises:
identifying a location where the first object resides;
identifying a plurality of objects residing at the location; identifying one or more formatting characteristics shared by the first object and the plurality of objects residing at the location; and
including the identified one or more formatting characteristics in the profile.

11. The computerized device of claim 1 wherein exporting the formatted version of the second object comprises:
exporting the second object with information associated with the second object, the information including at least one of:
i) a name of a user responsible for creating the second object;
ii) a name of a user responsible for editing the second object;
iii) at least one second object metadata associated with the second object;
receiving a selection to store the formatted version of the second object; and
storing the formatted version of the second object.

12. (canceled)

13. A computer-implemented method comprising:
examining an object descriptor containing metadata, the metadata associated with a first object;
identifying at least one formatting characteristic of the first object using the metadata;
applying the at least one formatting characteristic of the first object to a second object to alter the format of the second object without adding content to the second object, wherein applying the at least one formatting characteristic of the first object to the second object comprises accessing a profile of the first object, the profile defining one or more formatting characteristics of the first object, and formatting the second object according to the profile; and
exporting the second object as formatted with the at least one formatting characteristic of the first object and accessible independently of the first object.

14. The computer-implemented method of claim 13 further comprising prior to examining the object description, receiving input identifying the first object.

15. The computer-implemented method of claim 14 wherein receiving the input identifying first object comprises:
receiving selection of the first object via a graphical user interface wherein the first object is selected as a profile, by which the second object will be formatted.

16. The computer-implemented method of claim 15 wherein receiving the selection of the first object via the graphical user interface comprises:
receiving a selection of the first object from a plurality of sample objects displayed in the graphical user interface, the selection of the first object indicating a method by which to export the second object.

17. (canceled)

18. The computer-implemented method of claim 13, further comprising creating the profile of the first object, based on the one or more formatting characteristics of the first object, wherein creating the profile comprises eliminating extraneous data contained within the at least one formatting characteristic to ensure the second object is accessible, the extraneous data potentially causing the second object to be inaccessible.

19. The computer-implemented method of claim 17 wherein creating the profile comprises;
identifying a location where the first object resides;
identifying a plurality of objects residing at the location; determining one or more formatting characteristics shared by the first object and the plurality of objects; and
using the determined one or more formatting characteristics in the profile.

20. A non-transitory computer readable medium with computer programming logic stored therein that when executed on a processor in a computerized device produces an object profiling process, the programming logic comprising:
logic for examining an object descriptor containing metadata, the metadata associated with a first object;
logic for identifying at least one formatting characteristic of the first object using the metadata;
logic for applying the at least one formatting characteristic of the first object to a second object to alter the format of the second object without adding content to the second object, wherein applying the at least one formatting characteristic of the first object to the second object comprises accessing a profile of the first object, the profile defining one or more formatting characteristics of the first object, and formatting the second object according to the profile; and
logic for exporting the second object, wherein the second object is formatted with the at least one formatting characteristic of the first object and is accessible independently from the first object.

21. The computer-implemented method of claim 13, wherein the first object comprises
a first electronic file containing digital image content and the second object comprises a second electronic file containing digital image content.

22. (canceled)

23. The computer-implemented method of claim 13, further comprising:
receiving a selection of the first object via a graphical user interface of a digital camera.

24. (canceled)

25. The computer-implemented method of claim 13, wherein the first object comprises a digital photograph and identifying at least one formatting characteristic of the first object using the metadata comprises examining Exchangeable Image File Format (EXIF) data associated with the digital photograph.

26-33. (canceled)

34. The computerized device of claim 1, wherein the first object comprises a digital image file stored at a location, the second object comprises a digital image file, and exporting the formatted version of the second object comprises storing, at the location, the second digital image file as formatted according to the at least one formatting characteristic of the first object.

35. The non-transitory computer-readable medium of claim 20, further comprising:
logic for providing a graphical user interface and receiving input, via the graphical user interface, identifying the first object.

36. (canceled)

37. The non-transitory computer readable medium of claim 20, further comprising:
logic for creating, prior to accessing, the profile based on determining one or more formatting characteristics of the first object.

38. The non-transitory computer readable medium of claim 37, wherein creating the profile comprises:
determining a location at which the first object is stored;
determining at least one other object at the location;
determining a formatting characteristic shared by the first object and the at least one other object; and
including the formatting characteristic shared by the first object and the at least one other object in the profile.

39. The computerized device of claim 1 wherein identifying the at least one formatting characteristic of the first object and applying the at least one formatting characteristic to the second comprises identifying and applying a file size of the first object.

40. The computerized device of claim 1 wherein identifying the at least one formatting characteristic of the first object and applying the at least one formatting characteristic to the second comprises identifying and applying an amount of compression associated with the first object.
